(19) United States
(12) Patent Application Publication
(10) Pub. No.: US 2005/0144270 A1
(43) Pub. Date: Jun. 30, 2005

(54) Information distributing system

(76) Inventors: Masaaki Takase, Kawasaki (JP); Shinya Yamamura, Yokohama (JP); Katsunori Iwamoto, Yokohama (JP); Yoichiro Igarashi, Kawasaki (JP); Shinji Yamane, Yokohama (JP); Haruyuki Takeyoshi, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/878,086

(22) Filed: Jun. 28, 2004

(30) Foreign Application Priority Data
Dec. 15, 2003 (JP) 2003-416904

(51) Int. Cl. G06F 15/16; G06F 15/173

(52) U.S. Cl. 709/223

(57) ABSTRACT

An information distributing system comprises a startup condition management device inputting and holding a startup condition per user possessing a user terminal, inputting and holding context per user, and comparing the startup condition with the context for the same user and outputting, when both are coincident with each other, a service startup request including startup condition information and the context, and a service execution device outputting, when receiving the service startup request, a service execution request corresponding to the user terminal or controllable resources associated with the user terminal based on the startup condition information and the context included in the service startup request. The startup condition information can be provided from the user terminal or the service execution device. The service execution device outputs the service execution request through a service execution auxiliary device as required. The context can be provided to the startup condition management device through the user terminal itself or a context collection device.

### BACKGROUND OF THE INVENTION

1. Field of the Invention

The present invention relates to an information distributing system, and in particular to an information distributing system used for new network services, what one calls ubiquitous services.

New ubiquitous network services which exceed existing mobile services by developing conventional network services and incorporating on-site (on-the-job) functions or facilities into a part of services through network functions have been demanded in all aspects of daily life.

2. Description of the Related Art

Following two points can be mentioned as characteristics (restrictions) of existing network services represented by a mobile phone: Firstly, a startup condition (trigger) device and a terminal device for services are the same; Secondly, a device which a user himself or herself has purchased or prepared such as a general mobile phone or a notebook personal computer is carried when he or she gets access to services, which leads to an establishment of mobile services.

Meanwhile, an idea of ubiquitous computing, which came into existence in the latter half of 1980's, has been recently receiving attention. The characteristics of “ubiquitous”, while unified contents thereof have not been yet established due to various interpretations at present, are considered to be a system helping various daily objective acts by utilizing “on-site” function devices (resources such as computers).

On one hand, although a high-performance mobile terminal has been acceleratingly developed for the present mobile services, in many cases the mobile terminal incorporates functions which general users hardly make use of, together with a complicated operation due to the high performance, and cost increase of the mobile terminal, in addition to a physical limitation (size and weight) as mobile terminal devices. Thus, electronics devices having a keyword of “mobile” have encountered various difficulties in a trade-off between easy acceptance by a market and high performance.

On the other hand, a ubiquitous service in a broad sense aims at using “on-site” functional devices, and it is an ideal that a user need not always carry a functional device such as a notebook personal computer for achieving an object.

From this point of view, following conventional technologies have been proposed.

(1) A method and a system for information guidance adaptable to individuals, and a recording medium recording a program for information guidance adaptable to individuals in which, in order to provide a user with such information that a correspondence between a place and information depends on neither a subject nor a production intention of a specific person and present, past, and future context information of the user is reflected, a retrieval is performed with the context information as a retrieval condition, context dependent on present context, past context, and future context are extracted, the information thus obtained is transmitted from a server portion to a client portion, and the information thus received is displayed on a display of the client portion (see e.g. patent document 1).

(2) A method and a device for providing asynchronous service with context change as trigger and a program recording medium thereof in which, in order to keep continuity of a service until environment satisfying a request of a user is arranged, and to improve a usage ratio of network resources by flexibly adapting to context change or a temporary variation of availability of the network resources, a condition space is reset on the basis of new context information when a trigger transmitted from an external context information acquisition system is received, packaging is performed again, and it is provided to the user in case of success (see e.g. patent document 2).

(3) A context recognition retrieval service in which, in order to provide appropriate and narrowed retrieval results to users of mobile communication devices, a virtual network operator selectively transmits a customized request to a service provider, and a result based on a response from the service provider is provided to a terminal (see e.g. patent document 3).

(4) A context recognition market creating service in which, in order to provide customers with a variety of services offered by a plurality of service providers through a mobile virtual network operators system (MVNO) which is a single connection point for customers, the MVNO system itself generates a solicitation proposal to a customer based on a customer's purchase history (see e.g. patent document 4).

[Patent Document 1]

Japanese Patent Application Laid-open No. 2001-306604

[Patent Document 2]

Japanese Patent Application Laid-open No. 2002-108812

[Patent Document 3]

Japanese Patent Application Laid-open No. 2003-216641

[Patent Document 4]

Japanese Patent Application Laid-open No. 2003-216859

However, in the above-mentioned existing network system (information distributing system), a service action point (terminal point) is a user terminal itself possessed by a user as observed from the user terminal, and there has been no sufficient technology to temporarily and easily make use of devices (resources) without prior usufruct right or property right. Although it is essential for such a technology to make use of context estimated by various action patterns and tastes of users as a parameter, there has been no system for that purpose.

Also, since user information is concentrated on a single point, a throughput due to the concentration of the information becomes enormous, which is not safe in terms of information security.

### SUMMARY OF THE INVENTION

Accordingly, the objects to be achieved by the present invention are as follows:

(1) To retrieve resources except resources (e.g. a mobile phone) possessed by a user himself or herself and to enable services to be performed to the resources;

(2) To avoid concentration of user information on a single point, to start up an appropriate service according to a user's state, and to select resources.

In order to achieve the above-mentioned objects, an information distributing system according to the present invention comprises: a startup condition management device having means which inputs and holds a startup condition per user possessing a user terminal, means which inputs and holds context per user, and means which compares the startup condition with the context for the same user and outputs, when both are coincident with each other, a service startup request including the startup condition and the context; and a service execution device outputting, when receiving the service startup request, a service execution request corresponding to the user terminal or controllable resources related to the user terminal based on the startup condition and the context included in the service startup request.

Namely, a startup condition (trigger) management device inputs and holds a startup condition and context per user from outside, and when the startup condition and the context of the same user are coincident with each other, a service startup request is outputted.

A service execution device having received such a service startup request outputs a service execution request corresponding to a user terminal or controllable resources (e.g. device around the user terminal) related to the user terminal based on the startup condition and the context included in the service startup request.

Thus, it becomes possible to apply service startup not only to the user terminal but also to the resources associated with the user terminal, for the service execution. In this case, the service execution device can recognize resource information around the user, and can select appropriate resources among the around resources.

Also, the context per user is inputted only to the startup condition management device to be held, so that the service execution device does not need to hold the context. Therefore, a context concentration can be avoided.

Also, the startup conditions can be variously set up. Therefore, the service startup is made possible by the user context, not only in the case where the user explicitly instructs the service execution but also in the case where the user does not explicitly instruct it.

The above-mentioned startup condition per user may be provided from the user terminal or the service execution device to the startup condition management device.

Furthermore, the service execution device may obtain an assistance from a service execution auxiliary device as required to output the service execution request. Namely, the service execution device need not to be provided with all of service execution functions. By distributing a part of the functions to the service execution auxiliary device, the service execution request can be provided to resources through the service execution auxiliary device as required.

Also, the context may be designated by the user at the user terminal and may be provided to the startup condition management device from the user terminal. Alternatively, a context collection device may be further provided, the user terminal may transmit a context collection request to the context collection device, the context collection device may transmit the collected context to the user terminal in response to the request, and then the user terminal may provide the context to the startup condition management device.

Thus, it becomes unnecessary for the service execution device to notify the context to the startup condition management device, so that it becomes possible to avoid the concentration of the user context as mentioned above.

Also, when the context collection device is provided, the service execution device may transmit a context collection request to the context collection device, the context collection device may transmit the collected context to the service execution device in response to the request, and the service execution device may output the service execution request based on the received context and the context included in the service startup request.

Thus, even when appropriate resources can not be found by the context included in the service startup request and the service can not be executed, it becomes possible to execute the service by the context acquired by the service execution device itself from the context collection device.

Also, not only the service execution device but also the service execution auxiliary device may transmit a context collection request to the context collection device through the service execution device, the context collection device may transmit the collected context to the service execution auxiliary device through the service execution device in response to the request, and the service execution auxiliary device may output the service execution request based on the received context and the context included in the service startup request.

Also, the present invention may further comprise a resource management device managing the resources, the resource management device, when receiving a resource retrieval request from the service execution device, may respond to the service execution device with corresponding resources, and the service execution device may output the service execution request for the corresponding resources.

Thus, it becomes possible for the service execution device to select optimum resources among a plurality of resources.

The above-mentioned startup condition may include a lifetime (or expiration time) as session information. Thus, it becomes possible to set up an expiration time for holding the startup condition information in the startup condition management device.

Also, the user terminal may have an interface for editing or deleting the context held by the startup condition management device. Thus, the context which keeps on increasing in the startup condition management device can be deleted or edited from the user terminal side.

On the other hand, when a plurality of service execution devices exist, the startup condition information may include an identifier of the user terminal at each service execution device and a specific address of the service execution device, and the startup condition management device may have a correspondence table of a specific address of each service execution device and an identifier of each user terminal at each service execution device and the startup condition management device.

Thus, the startup condition management device can determine, referring to the correspondence table, the startup condition information by recognizing which service execution device has set up the user terminal corresponding to the user terminal set up by its own device.

Also, on the contrary, when a plurality of startup condition management devices exist, the startup condition information may include an identifier of the user terminal at each startup condition management device and a specific address of the startup condition management device, and the service execution device may have a correspondence table of a specific address of each startup condition management device and an identifier of each user terminal at each startup condition management device and the service execution device.

Namely, the service execution device holds a similar correspondence table, thereby enabling the present invention to accommodate to the case where a plurality of startup condition management devices exist.

Furthermore, if an immediate startup is adapted to be included in the startup condition, it becomes possible to provide a service including such an immediate execution that has been desired in the prior art example.

It is to be noted that “information” distributed in the present invention includes not only contents but also driving control information of “on-site” mechanical devices such as motors.

As described above, an information distributing system according to the present invention is arranged such that a startup condition management device holds a service startup condition and resource information around a user as context, uses the information as a trigger, and notifies the resource information according to the request of the service execution device. Therefore, it becomes possible for the service execution device to recognize the information of resources around the user and to select an optimum resource therefrom.

Also, the service execution device or the user terminal sets up the startup condition to a startup condition management device, whereby a designated user will receive a startup notification when it meets a designated condition, and the service execution device need not notify the context to the startup condition management device. Thus, the concentration of user context can be avoided.

Furthermore, it becomes possible to start up the service by the user context even if the user does not give explicit instructions.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an overall arrangement of an information distributing system according to the present invention;

FIG. 2 is a block diagram showing an internal arrangement of a user terminal shown in FIG. 1;

FIG. 3 is a block diagram showing an internal arrangement of controllable resources shown in FIG. 1;

FIG. 4 is a block diagram showing an internal arrangement of a resource management device (RES-OP) shown in FIG. 1;

FIG. 5 is a block diagram showing an internal arrangement of a startup condition management device (UA) shown in FIG. 1;

FIG. 6 is a block diagram showing an internal arrangement of a service execution device (S-ORG) shown in FIG. 1;

FIG. 7 is a block diagram showing an internal arrangement of a service execution auxiliary device (S-COMP) shown in FIG. 1;

FIG. 8 is a block diagram showing an internal arrangement of a context collection device shown in FIG. 1;

FIG. 9 is a diagram showing an embodiment of an overall arrangement of the present invention shown in FIG. 1;

FIG. 10 is a sequence diagram showing an overall operation of the present invention;

FIG. 11 is a sequence diagram showing startup condition setup processing by a user terminal of the present invention;

FIG. 12 is a diagram showing an example of a context deleting (editing) interface used in FIG. 11;

FIG. 13 is a sequence diagram of startup condition setup processing by a service execution device in the present invention;

FIG. 14 is a sequence diagram of a context collection/setup processing by user's instructions in the present invention;

FIG. 15 is a sequence diagram of service startup processing in the present invention;

FIG. 16 is a sequence diagram of context acquisition/setup processing by instructions of a service execution device in the present invention; and

FIG. 17 is a sequence diagram of context collection/setup processing by instructions of a service execution auxiliary device in the present invention.

### DESCRIPTION OF THE EMBODIMENTS

Hereinafter, the best mode for carrying out an information distributing system according to the present invention will be described referring to figures attached.

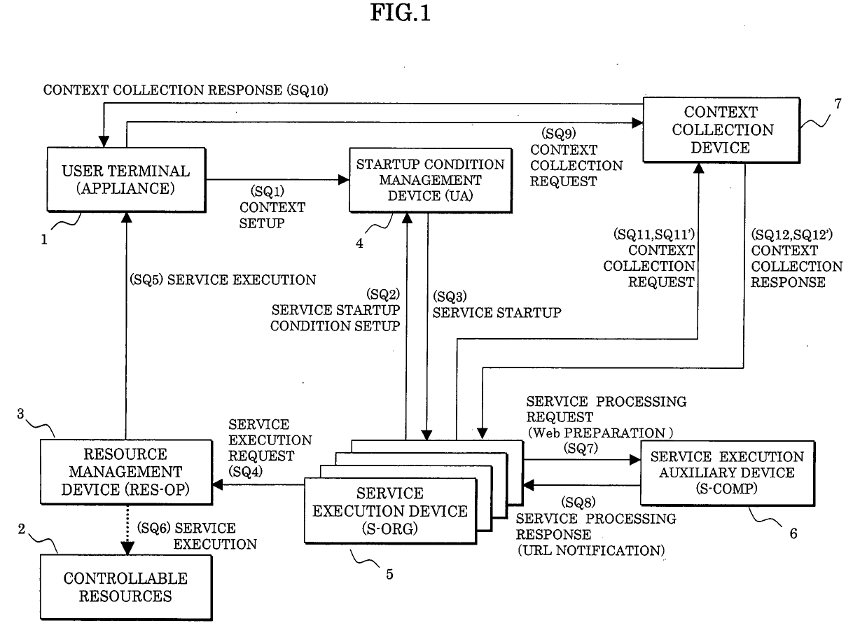

FIG. 1 shows an overall arrangement of an information distributing system according to the present invention, which is composed of a user terminal (appliance) 1, controllable resources 2, a resource management device (RES-OP) 3, a startup condition management device (UA) 4, a service execution device (S-ORG) 5, a service execution auxiliary device (S-COMP) 6, and a context collection device 7.

An operation sequence of the information distributing system according to the present invention having such an arrangement will now be schematically described.

The actual user terminal 1 performs a context setup to the startup condition management device 4 (sequence SQ1), and the service execution device 5 sets up a service startup condition (sequence SQ2). Then, the startup condition management device 4 compares the set up context with the service startup condition, and when both are coincident with each other, a service startup is applied to the service execution device 5 (sequence SQ3).

The service execution device 5 having received the service startup performs a service execution request to the resource management device 3 (sequence SQ4). In response to the request, the resource management device 3 performs a service execution to the user terminal 1 (sequence SQ5), or applies the service execution to the controllable resources 2 around the user terminal 1 (sequence SQ6).

On the other hand, there are some cases where the service execution device 5 does not have all of the data for the service execution. For these cases, the service execution auxiliary device 6 is provided. The service execution device 5 performs a service execution auxiliary request (e.g. Web preparation request) as required (sequence SQ7). In response to this request, the service execution auxiliary device 6 sends back a service execution auxiliary result (e.g. URL notification). Therefore, the service execution device 5 can perform the service execution request in the same way as the above operation by using the service execution auxiliary result.

The user terminal 1 performing the context setup at the above-mentioned sequence SQ1 does so by itself, and besides, the user terminal 1 performs a collection request to the context collection device 7 (sequence SQ9). When the context collection device 7 returns the context in response to the collection request (sequence SQ10), the user terminal 1 performs the context setup by using the returned context.

In some cases, the resources 2 can not accommodate to the service execution device 5 or the service execution auxiliary device 6 by the context included in the service startup request. Therefore, it is possible that context is required to be preliminarily held independently.

Thus, the service execution device 5 performs the collection request to the context collection device 7 (sequence SQ11). In response to the request, the context collection device 7 sends back the response (sequence SQ12), thereby enabling the service execution device 5 to hold the context. This is also applied to the case where the service execution auxiliary device 6 performs the context collection through the service execution device 5 (sequences SQ11′ and SQ12′).

Hereinafter, an internal arrangement of each block shown in FIG. 1 and its function will be described.

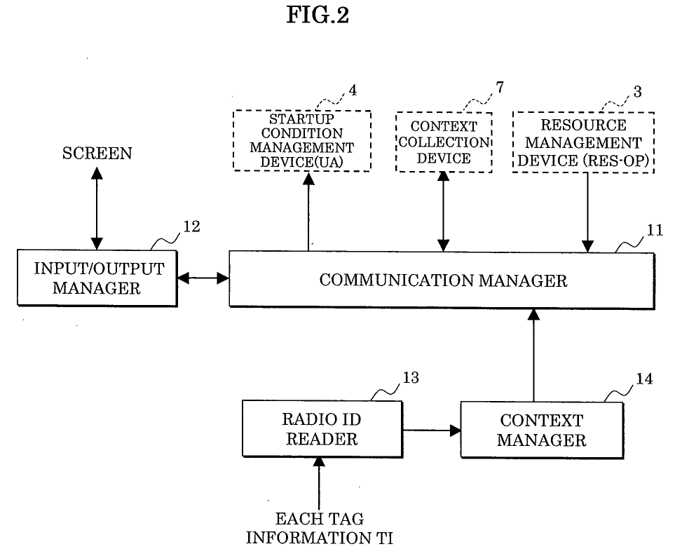

User Terminal 1: FIG. 2

The user terminal 1 is composed of, as shown in FIG. 2, a communication manager 11 realizing an interface with the resource management device 3, the startup condition management device 4, and the context collection device 7 as external entities (shown by dashed lines), an input/output manager 12 outputting a screen (Web screen) required for its own terminal by processing request from the resource management device 3, a radio ID reader 13 serving as a window of context information and reading radio ID tag information TI, and a context manager 14 which passes the context information to the communication manager 11 based on the tag information TI received from the radio ID reader 13.

Namely, when the read tag indicates a user ID, the context manager 14 having received each tag information TI read by the radio ID reader 13 notifies the user ID information to the startup condition management device 4 from the communication manager 11. When the tag does not indicate a user ID, the tag information is passed to the context collection device 7 through the communication manager 11, and an ad hoc list as the context sent back from the context collection device 7 is registered in the startup condition management device 4 through the communication manager 11.

The ad hoc list registered in the startup condition management device 4 is provided as the Web screen from the communication manager 11 through the input/output manager 12. The user of the user terminal 1 edits or deletes associated information through the Web screen.

Accordingly, the user terminal 1 has following functions:

(1) A function of identifying a user and holding user information (user ID, etc.);

(2) A function of receiving context from the context collection device 7 to be transmitted to the startup condition management device 4;

(3) A function of having an interface with a user, and providing the context designated by the user to the startup condition management device 4.

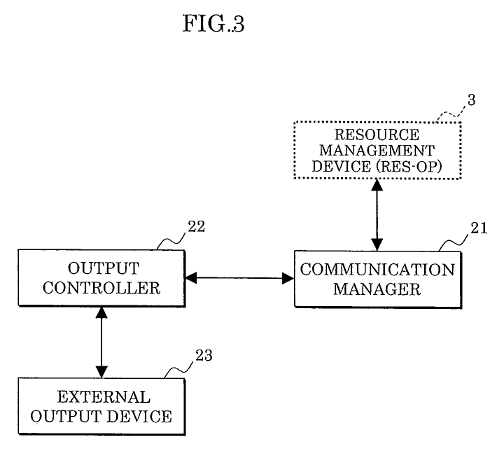

Controllable Resources 2: FIG. 3

The controllable resources 2 are composed of, as shown in FIG. 3, a communication manager 21 realizing an interface with the resource management device 3, and an output controller 22 providing an output to an external output device 23 according to instructions from the resource management device 3.

Accordingly, the controllable resources 2 have following functions:

(1) A function of managing the state of the external output device 23, and transmitting the state of the external output device 23 as resources to the resource management device 3;

(2) A function of receiving the service execution request from the resource management device 3 and performing a predetermined service processing.

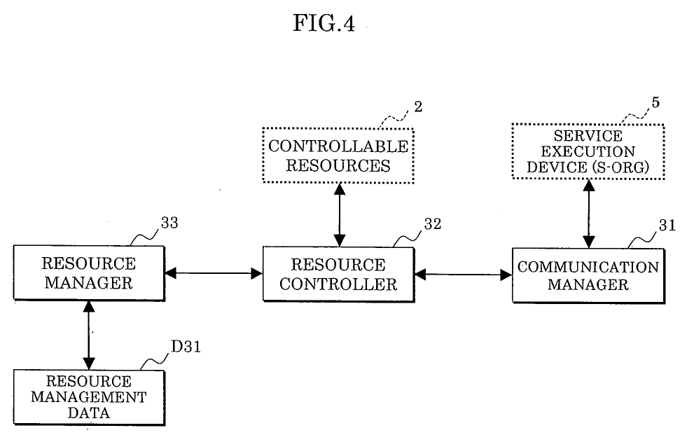

Resource Management Device 3: FIG. 4

The resource management device 3 is composed of, as shown in FIG. 4, a communication manager 31 realizing an interface with the service execution device 5 and absorbing a difference of synchronous/asynchronous processing of messages between entities (between external devices), a resource controller 32 starting up processing (screen output etc.) specific to the resources according to the contents of the context included in the service execution request, and a resource manager 33 responding, in order to manage the resources 2, to an inquiry from the resource controller 32 with the state of the resources 2 based on resource management data D31 upon requesting the service execution from the service execution device 5.

Accordingly, the resource management device 3 has following functions:

(1) A function of managing the resources 2, and responding to the service execution device 5 with the resources 2 meeting the condition in the presence of a retrieval request of the resources 2 from the service execution device 5;

(2) A function of transmitting the service execution request to the managed resources 2 by the request from the service execution device 5.

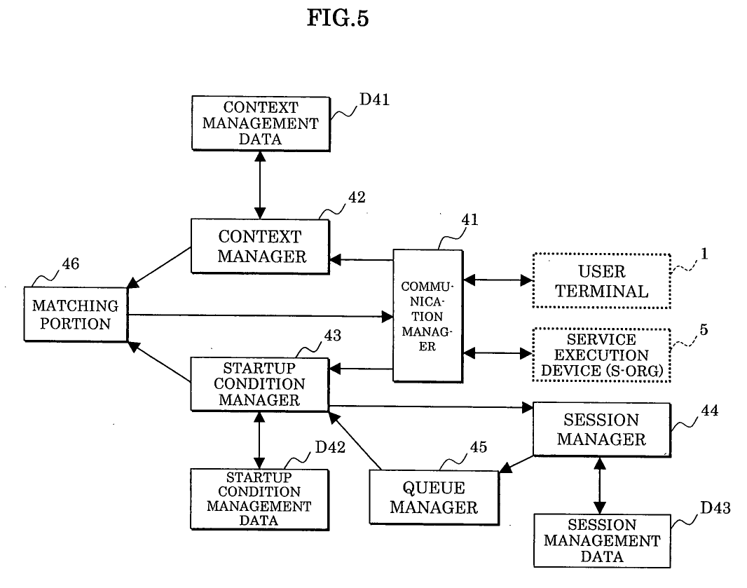

Startup Condition Management Device 4: FIG. 5

The startup condition management device 4 is composed of, as shown in FIG. 5, a communication manager 41 realizing an external interface with the user terminal 1 and the service execution device 5; a context manager 42 managing context management data D41 and having a notification function required for the operation of a matching portion 46; a startup condition manager 43 managing startup condition management data D42 and having a notification function required for the operation of the matching portion 46; a session manager 44 registering a session ID corresponding to the startup condition in session management data D43 upon setting up the service startup condition in order to realize the management of the startup condition session, monitoring a lifetime of the startup condition session, and notifying a session finish to a queue manager 45 with respect to a session whose lifetime has expired; the queue manager 45 realizing a queue management of the startup condition manager 43 and making a startup condition deleting request to the startup condition manager 43 upon receiving a session finish notification of the session manager 44; and the matching portion 46 inputting the context information from the context management data D41 of the context manager 42, detecting the service startup request from the startup condition management data D42 of the startup condition manager 43, performing matching of both, and transmitting a processing request message of the service startup to the service execution device 5 which is a transmission source of the service startup request when the service startup condition is met.

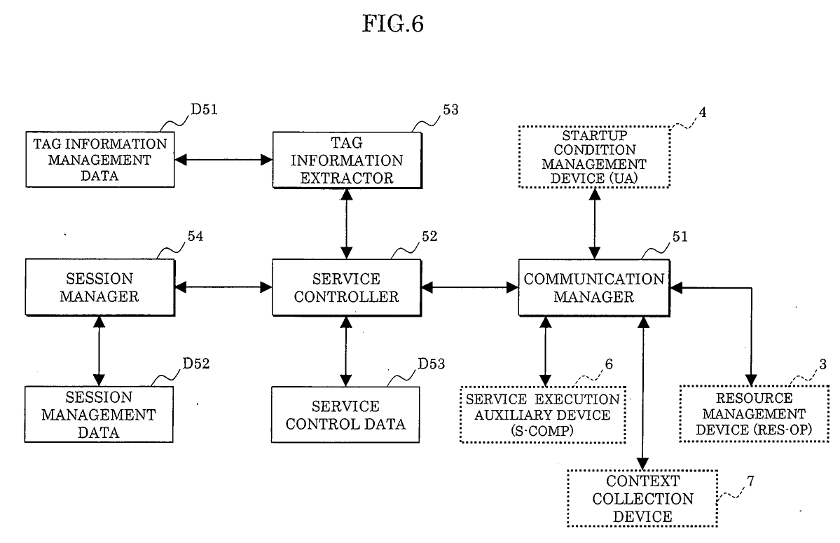

It is to be noted that when receiving a context registration message, the communication manager 41 passes the processing to a service controller 52 (see FIG. 6) of the service execution device 5 to restore its original state. Therefore, an indirect asynchronous processing between the user terminal 1 and the service execution device 5 is realized and a Web interface with the user terminal 1 is mounted thereon.

Also, the context management data D41 hold the latest context information per user, and store information required for the operation of the matching portion 46.

A “context” in the above description includes all of objects (including person, thing, place) associated with a user at the present time, a user's state (working etc.), a surrounding situation, a history, a future schedule, and the like.

Furthermore, the startup condition management data D42 hold a list of the service startup condition per user, and store information required for the operation of the matching portion 46.

Also, the session management data D43 store therein information required for the management of the startup condition session.

Accordingly, the startup condition management device 4 has following functions:

(1) A function of setting up/holding the startup condition per user by the startup condition setup request from the service execution device 5;

(2) A function of setting up/holding the context per user by the context setup request from the user terminal 1 and another context collection device 7;

(3) A function of monitoring the contents set up as the startup condition and the contents of the context, and of transmitting the service startup request to the service execution device 5 when both contents are coincident with each other.

Service Execution Device 5: FIG. 6

The service execution device 5 is composed of, as shown in FIG. 6, a communication manager 51 realizing an external interface with the user terminal 1, the resource management device 3, and the startup condition management device 4 and absorbing the difference of synchronous/asynchronous processing of the messages between the external devices; a service controller 52 requesting processings such as service startup condition setup, service execution, and outputting of each portion, based on service control data D53 for realizing a processing logic specific to service; a session manager 54, in order to realize a management of the startup condition session, registering a session corresponding to the startup condition in session management data D52 according to the request from the service controller 52 upon service startup condition setup, deleting the session of the startup condition related to the service to be started according to the request from the service controller 52 upon receiving the service startup request, monitoring the lifetime of the startup condition session having registered, and executing an autonomous deletion of the session whose lifetime has expired; and a tag information extractor 53 realizing an extracting function of information corresponding to tag information management data D51 in which information corresponding to the tag ID is stored. It is to be noted that the service control data D53 store information required for the operation of the service controller 52, and store setup contents of e.g. the startup condition.

Accordingly, the service execution device 5 has following functions:

(1) A function of setting up the service startup condition per user to be transmitted to the startup condition management device 4;

(2) A function of receiving the service startup request from the startup condition management device 4, performing a communication with the service execution auxiliary device as required, and executing services such as Web screen preparation;

(3) A function of requesting an output (Web screen display) of the user terminal 1 or the resource management device 3 based on the notification of the service execution result from the service execution auxiliary device 6.

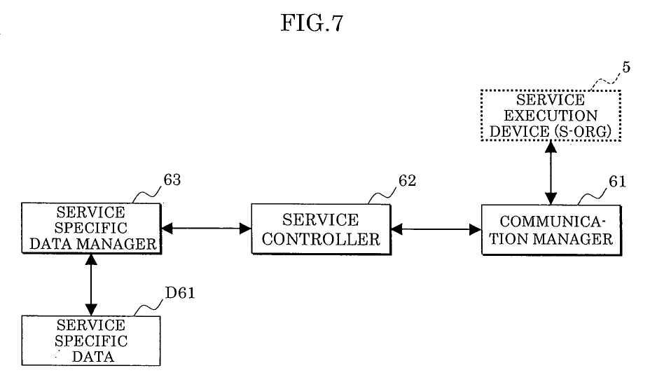

Service Execution Auxiliary Device 6: FIG. 7

The service execution auxiliary device 6 is composed of, as shown in FIG. 7, a communication manager 61 realizing an interface with the service execution device 5 and absorbing the difference of synchronous/asynchronous processing of messages between external devices; a service controller 62 starting up the processing (e.g. processing of reaching office or leaving office) specific to the service corresponding to the contents of the context included in the service execution request, in order to realize a processing logic specific to the service; and a service specific data manager 63 setting up reaching office data and leaving office data to service specific data D61 in which a reaching/leaving office situation e.g. per user, per month is stored according to the request from the service controller 62.

Accordingly, the service execution auxiliary device 6 has following functions:

(1) A function of executing a part of a service execution procedure by the request from the service execution device 5;

(2) A function of transmitting the execution result to the service execution device 5.

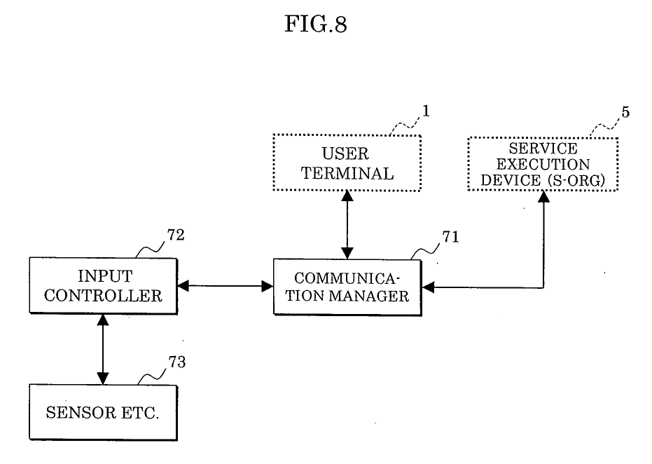

Context Collection Device 7: FIG. 8

The context collection device 7 is composed of, as shown in FIG. 8, a communication manager 71 realizing an interface with the user terminal 1 and the service execution device 5, and an input controller 72 controlling information collection from a sensor etc. 73 and passing the information to the communication manager 71.

Accordingly, the context collection device 7 has a following function:

(1) A function of collecting a certain specific context and transmitting the information to the user terminal 1, the service execution device 5, and the like.

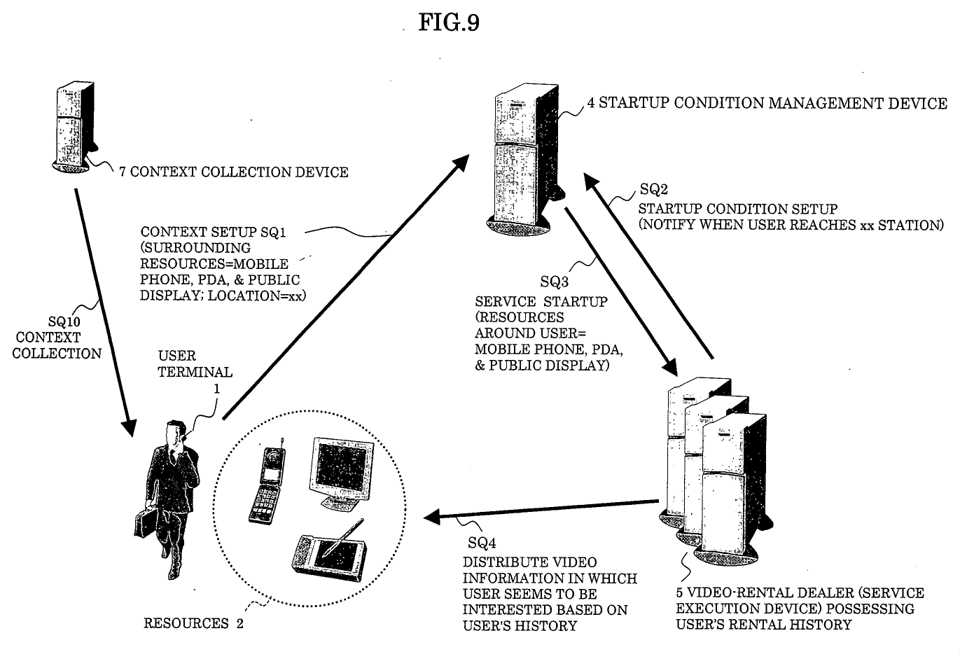

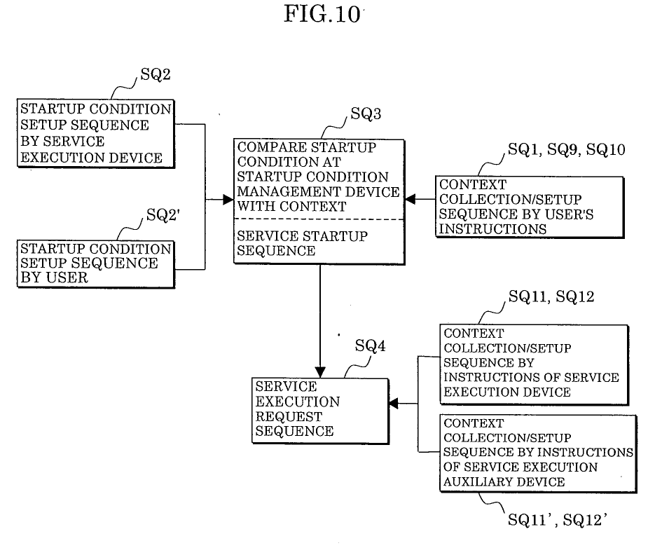

### Embodiment: FIGS. 9 and 10

FIG. 9 shows an application example actually used in the arrangement of the present invention shown in FIG. 1. It is to be noted that the service execution auxiliary device 6 and the resource management device 3 shown in FIG. 1 are omitted in this application example for the sake of simplification.

In FIG. 9, the context setup is performed from the user terminal 1 (e.g. mobile personal computer) possessed by the user (sequence SQ1). The context in this case is either held by the user terminal 1 itself or is collected by the context collection device (sequence SQ10). This context indicates a mobile phone, a PDA, and a public display as the resources 2 around the user terminal 1, and further includes “user terminal location=xx”. Namely, the user sets up the context indicating that the resources around the user terminal 1 at the location xx are the mobile phone, the PDA, and the public display in the startup condition management device 4.

A video-rental dealer (server) 5 as the service execution device sets up the startup condition in the startup condition management device 4 having received such a context (sequence SQ2). The startup condition in this case is e.g. “Notify when the user reaches a xx station”. The startup condition management device 4 compares the context set up by the user terminal 1 with the startup condition set up by the video-rental dealer 5, and performs the service startup when both are coincident with each other (location xx=xx station) (sequence SQ3). The example of the service startup in this case includes that the resources 2 around the user are the mobile phone, the PDA, and the public display.

The video-rental dealer 5 having received the service startup from the startup condition management device 4 preliminarily holds a user's rental history or the like, and distributes, in consideration of the contents of the service startup, video information in which the user seems to be interested based on the user's history as the service execution request (sequence SQ4). Thus, the user terminal 1 or the surrounding resources 2 output the video information in which the user seems to be interested at the xx station.

FIG. 10 shows a sequence of the application example shown in FIG. 9.

Namely, firstly the sequence SQ1 of the context collection and the setup (SQ9 and SQ10) is executed by the user's instructions. Also, the startup condition setup sequence SQ2 by the service execution device 5 is executed. It is to be noted that as shown in FIG. 10, while not shown in FIGS. 1 and 9, a startup condition setup sequence SQ2′ by the user may be performed.

By these sequences SQ1 and SQ2, the startup condition is compared with the context at the startup condition management device 4. When both are coincident with each other, the service startup processing sequence is performed to the service execution device 5 (sequence SQ3). By receiving the service startup processing sequence SQ3, the service execution device 5 executes the service execution sequence SQ4.

It is to be noted that context collected from the context collection device 7 by the service execution device 5 or the service execution auxiliary device 6 itself may be added and then the service execution sequence SQ4 may be executed.

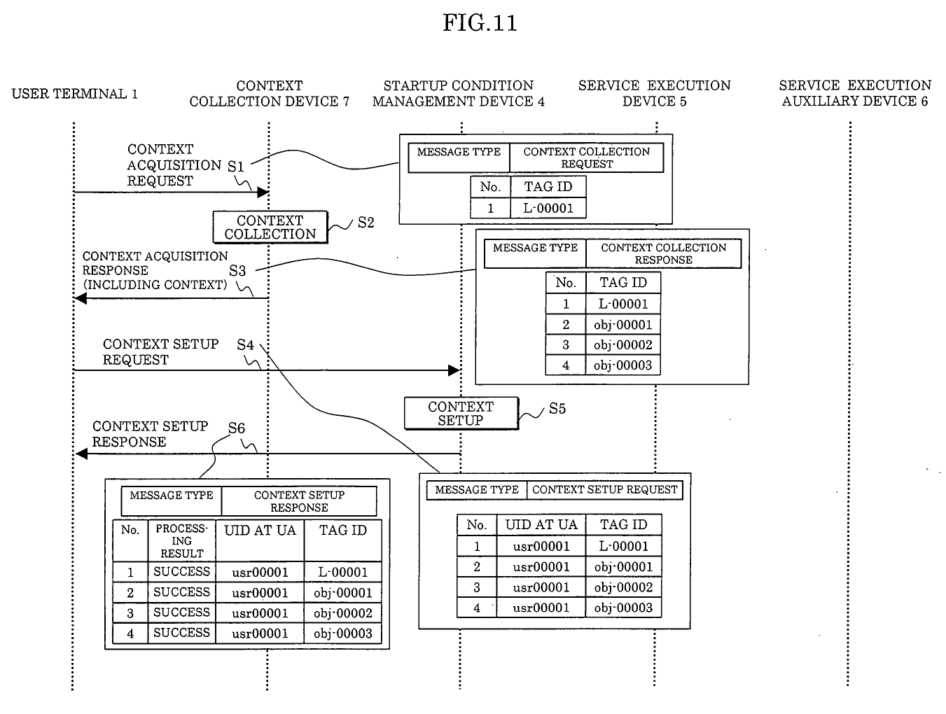

Hereinafter, the sequences shown in FIGS. 9 and 10 will be described referring to sequence examples shown in FIG. 11 and the subsequent figures. It is to be noted that while the resource management device 3 and the service execution auxiliary device 6 are omitted in FIGS. 9 and 10, these devices are added in the following description.

Firstly, in this embodiment, it is supposed that the service execution device 5 sets up the startup condition for the startup condition management device 4, the service execution device 5 is the video-rental dealer as mentioned in the above example, the lifetime of the startup condition is 3600 sec., and the startup conditions are as follows:

(1) Condition is set up for the user whose UID (user identifier) is usr00005 at the service execution device 5;

(2) When the user comes or goes to the location (xx station in this example) indicated by a tag ID=L-00001, information appropriate for the user is outputted to the resources which are optimum devices;

(3) Device around the user terminal 1 is a mobile phone, a monitor (public display) at a station, or a PDA. The tag IDs indicating the respective devices are
Mobile phone: obj-00001
Monitor at station: obj-00002
PDA: obj-00003.

(4) The service execution device 5 has a rental history of the user, and selects information appropriate based on the history. Since the rental history of the user includes numerous action movies, it is supposed that information of a new action movie is selected as optimum information. Also, even if this information is outputted to the monitor at a station, the contents of the information present no problem. Therefore, it is supposed that the monitor at the station with a larger screen is selected as an appropriate device.

Context Collection/Setup Sequence (SQ1) by User's Instructions: FIG. 11

(1) A user transmits a context collection request to the context collection device 7 by the user terminal 1 (at step S1). As an example of the context collection request, as shown in FIG. 11, “L-00001” is set up as a tag ID, and resources (devices) around the user terminal 1 at the “xx station” are inquired.

(2) The context collection device 7 collects required context or converts context held into an appropriate form (at step S2).

(3) The context collection device 7 sends back a message including the context as a context collection response to the user terminal 1 (at step S3). As an example of this response, since the tag IDs indicated by Nos.1-4 are included, as shown in FIG. 11, it is recognized that the user is located at the xx station, and the surrounding devices are the mobile phone, the monitor at the station, and the PDA.

(4) The user terminal 1 transmits the context setup request to the startup condition management device 4 (at step S4). In the context setup request in this case, as shown in FIG. 11, the same contents as collected from the context collection device 7 at step S3 are set up. The UID at the startup condition management device 4 in this case is “usr00001”.

(5) The startup condition management device 4 sets up the received context as the context of the user (UID=usr00001) (at step S5).

(6) The startup condition management device 4 transmits a context setup response to the user terminal 1 (at step S6). The context setup response indicates, as shown in FIG. 11, that the startup condition is accepted at the startup condition management device 4 (processing result=success). Therefore, it is recognized that the context setup request at step S4 is set up as it is at the startup condition management device 4.

It is to be noted that while the context collection request is performed to the context collection device 7 from the user terminal 1 in the sequence example of FIG. 11, and by this request the context setup is performed to the startup condition management device 4, steps S4-S6 may be directly executed without performing the above-mentioned steps S1-S3 when the user terminal 1 itself preliminarily holds the context.

Also, if the sequence of FIG. 11 is continued, context data are accumulated at the startup condition management device 4. Therefore, the sequence deleting or editing this is required.

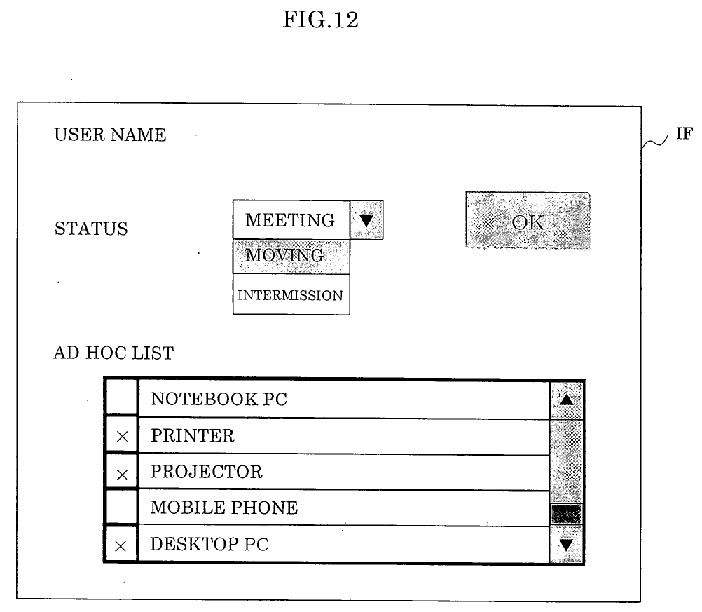

In that case, the user terminal 1 selects context (shown by x) desired to be deleted or edited by using a context deleting (editing) interface IF shown in FIG. 12, and transmits the context setup request (deletion or edition request in this case) to the startup condition management device 4 through the communication manager 11 by the user's instructions (press OK button). Then, the startup condition management device 4 receives the context setup request through the communication manager, and the context manager 14 deletes or edits the context data. The startup condition management device 4 in this case sends back the context setup response to the user terminal 1. Accordingly, such a data deletion (edition) sequence is executed in the same way as steps S4-S6 shown in FIG. 11.

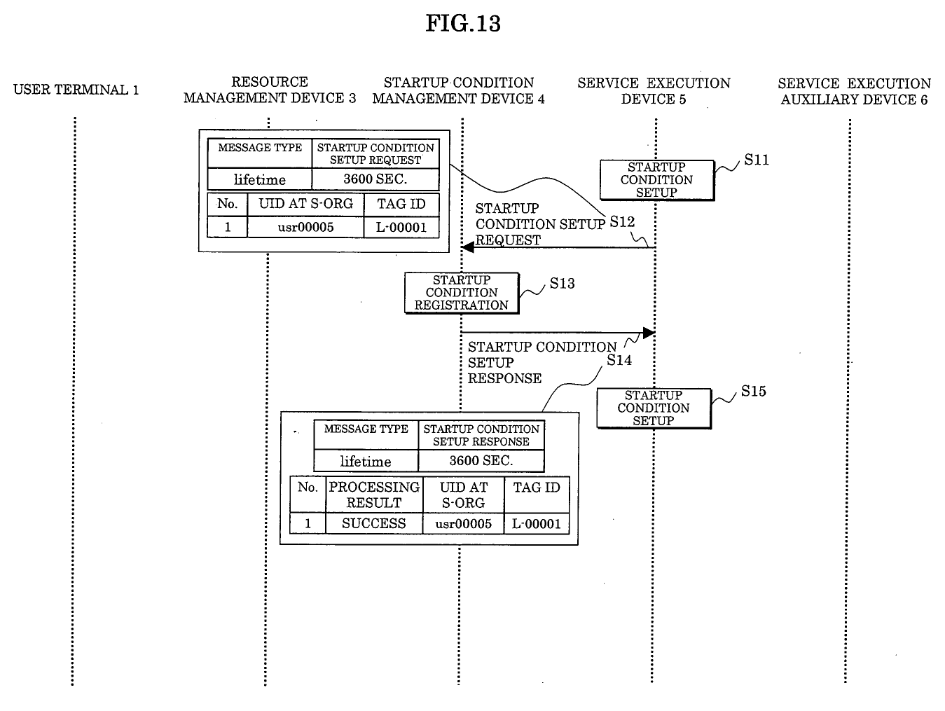

Startup Condition Setup Sequence (SQ2) by Service Execution Device 5: FIG. 13

(1) The service execution device 5 generates a startup condition setup message according to the contents of the service control data D53 (at step S11). When the service is immediately started up, the immediate service startup is set up as the startup condition as shown in the following table 1.

TABLE 1
CORRESPONDENCE TABLE HELD AT
STARTUP CONDITION MANAGEMENT DEVICE

| No. | UID AT UA | UID AT S-ORG | IP ADDRESS AT S-ORG |
|---|---|---|---|
| 1 | usr00001 | usr00005 | 11.22.33.44 |
| 2 | usr00002 | usr00007 | 11.22.33.45 |

When a startup after a fixed time is desired, the timing is set up in the service control data D53, and the timing is also set up in the startup condition setup.

(2) The service execution device 5 transmits the startup condition setup request to the startup condition management device 4 corresponding to the startup condition generated in the above (1) (at step S12). For the startup condition setup request, as shown in FIG. 13, 3600 sec. is set up as a lifetime, and the startup condition setup request indicates that the user whose user ID=usr00005 has come to the xx station is made a startup (trigger) condition.

(3) The startup condition management device 4 registers the startup condition in the startup condition management data D42 according to the message of the above (2) (at step S13). Also, the session information (lifetime=3600 sec.) is registered in the session management data D43, and a session management by the session manager 44 is started at the same time. Namely, this startup condition information is effective only for 3600 sec., and the session manager 44 manages the lifetime.

(4) The startup condition management device 4 notifies the setup result of the startup condition to the service execution device 5 that is a transmission source (at step S14). The execution result response in this case indicates, as shown in FIG. 13, that it has been successful (processing result=success) to have a condition “the user whose user ID-usr00005 has come to the xx station”. Namely, it indicates that the startup condition is set up as it is.

(5) The service execution device 5 registers the session information in the session management data D52 according to the above-mentioned startup condition setup response (at step S14), and starts the session management by the session manager 54 at the same time (at step S15).

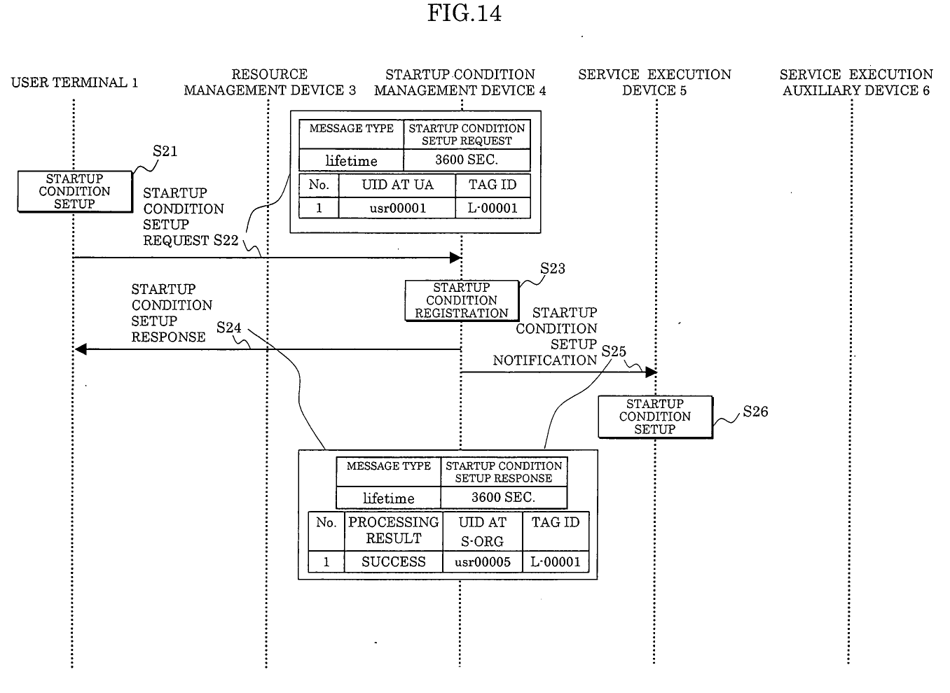

Startup Condition Setup Sequence (SQ2′) by User Terminal 1: FIG. 14

Although the startup condition is set up by the service execution device 5 in the above case of FIG. 13, the user terminal itself can set up the startup condition as follows:

(1) The user terminal 1 sets up a desired startup condition of a user (at step S21). In case where the immediate service startup is desired, it is added to the startup condition, as shown in the table 1 to be set up. If not the case, a fixed timing is included in the startup condition to be set up.

(2) The startup condition setup request is transmitted to the startup condition management device 4 corresponding to the startup condition generated by the above-mentioned (1) (at step S22). The startup condition setup request in this case indicates, as shown in FIG. 14, that the lifetime=3600 sec., and that the user whose user ID=usr00001 has come to the xx station is made a condition.

(3) The startup condition management device 4 registers, according to the above-mentioned startup condition setup request, the startup condition information in the startup condition management data D42 (at step S23). At the same time, the session information (lifetime=3600 sec.) is registered in the session management data D43, and session management by the session manager 44 is started.

(4) The startup condition management device 4 responds to the user terminal 1 with the execution result of step S23 (at step S24). At the same time, the startup condition management device 4 notifies the startup condition setup result to the service execution device 5 designated by the user (at step S25). The startup condition setup request at this time indicates, as shown in FIG. 14, that the lifetime=3600 sec. and that the user whose user ID=usr00005 has approached the xx station. It is to be noted that the reason why the startup condition setup result is notified to the service execution device 5 is that the processing of the startup condition management device 4 is required to be made coincident with that of the service execution device 5 in some cases.

(5) The service execution device 5 registers, according to the result of the above (4), the session information in the session management data D43, and starts the session management at the same time (at step S26).

Hereinafter, the operation in case where a plurality of service execution devices 5 exist will be described.

Firstly, the startup condition management device 4 has a correspondence table as shown in the following table 2.

TABLE 2

| | |
|---|---|
| MESSAGE TYPE | IMMEDIATE |
| | STARTUP |
| | REQUEST |

When the startup condition management device 4 receives a trigger setup request from the service execution device 5, the startup condition setup request at this time includes the user ID of the service execution device 5 and an IP address of the service execution device 5. In this example, the user ID=usr00005, and the IP address=11.22.33.44.

The startup condition management device 4 recognizes, referring to the correspondence table, that the user whose user ID=usr00005 of the service execution device 5 corresponds to the user whose ID=usr0001 of the startup condition management device 4, and holds the user ID=usr00005 as the startup condition of the user ID=usr00001.

Then, the startup condition management device 4 performs matching processing of the context. When the startup condition for the service startup of the user whose user ID=usr00001 is met, the service execution device 5 concerned is retrieved from the correspondence table. In this example, the user ID=usr00005, and the IP address=11.22.33.44 can be obtained.

It is to be noted that the service execution device 5 can accommodate to the case where a plurality of startup condition management devices 4 exist, by possessing a similar correspondence table.

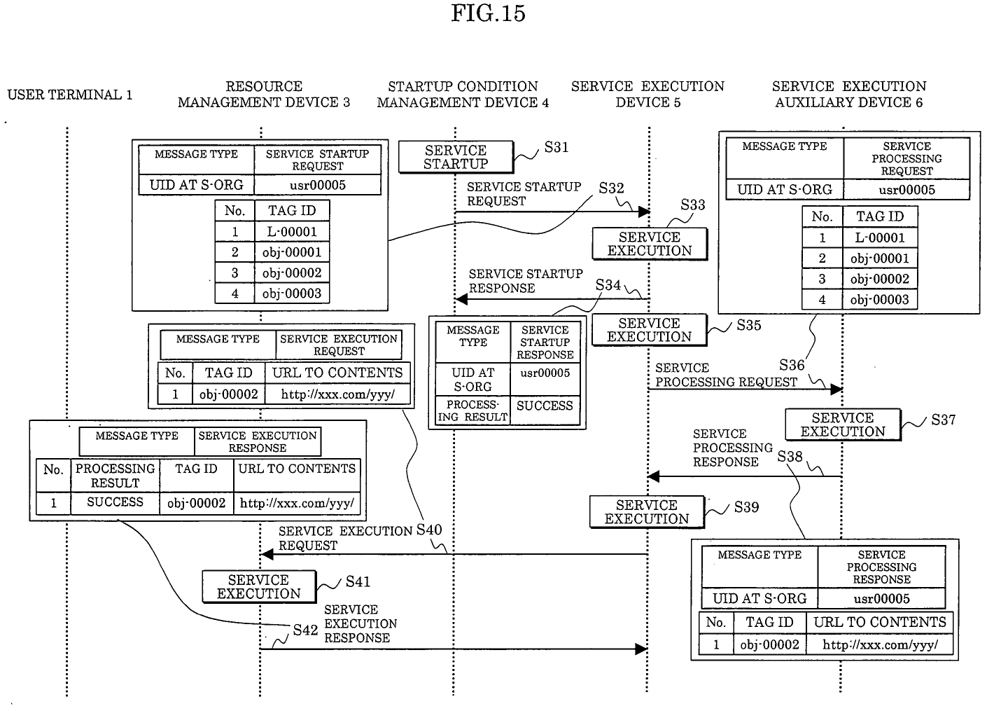

Service Start Up Sequence (SQ3): FIG. 15

(1) The startup condition management device 4 compares the context data with the contents of the startup condition. When both are coincident with each other, the session information is deleted from the session management data D43 to generate the service startup message (at step S31). It is to be noted that why the session information is deleted is to indicate that the process has already been executed.

(2) The startup condition management device 4 transmits the service startup request to the service execution device 5 corresponding to the startup condition of the above (1) (at step S32). This service startup request indicates, as shown in FIG. 15, that it is possible to perform the startup request to the mobile phone, the monitor at the station, or the PDA as the devices (resources) around the user terminal 1 when the user whose user ID=usr00005 at the service execution device has come to the xx station.

(3) The service execution device 5 deletes, according to the service startup request of the above (2), the concerned session information (at step S33).

(4) The service execution device 5 further transmits the service startup response to the startup condition management device 4 that is a transmission source (at step S34). This response includes, as shown in FIG. 15, the same data of the processing result=success.

(5) The service execution device 5 generates a service execution request message corresponding to the startup condition according to the service control device D53 (at step S35).

(6) The service execution device 5 further transmits the service processing request to the service execution auxiliary device 6 corresponding to the message of the above (5) as required (at step S36). This service processing request indicates, as shown in FIG. 15, that the user whose user ID=usr00005 at the service execution device 5 has come to the xx station, and a processing request in case where the devices around the user are the mobile phone, the monitor at the station, and the PDA. It is needless to say that other devices can be included.

(7) The service execution auxiliary device 6 executes corresponding processing according to the service processing request of the above (6) (at step S37).

(8) The service execution auxiliary device 6 notifies the execution result of step S37 to the service execution device 5 that is a transmission source (at step S38). As shown in FIG. 15, the service execution device 5 has, as mentioned above, the rental history of the user whose user ID=usr00005 at the service execution device 5, and selects information appropriate based on the history. Therefore, since the user's rental history includes numerous action movies in this case, information of a new action movie is selected as the information appropriate. The service execution auxiliary device 6 determines the information appropriate by considering an auxiliary history. It is indicated that since this information has contents which present no problem even if it is outputted to the monitor at the station, the monitor at the station with a larger screen is selected as an appropriate device for the service processing response. It is to be noted that a URL to the contents=http://xxx.com/yyy/ indicates a location of the information of the new action movie.

(9) If the service processing response of step S38 is normal, the service execution device 5 generates a service execution message (at step S39). This indicates that what kind of information is to be outputted to which device based on which history.

(10) The service execution device 5 transmits the service execution request to the appropriate user terminal 1 or the resource management device 3 according to the service control data D53 (at step S40). FIG. 15 shows an example of transmitting the service execution request from the service execution device 5 to the resource management device 3. The service execution request in this case is the same as the service processing response of step S38 as shown in FIG. 15.

(11) The resource management device 3 (or user terminal 1) executes output processing according to the service execution request of the above (10) (at step S41).

(12) The resource management device 3 (or user terminal 1) notifies the service execution response to the service execution device 5 that is a transmission source (at step S42). This is shown in FIG. 15 as an example when the service execution request is succeeded.

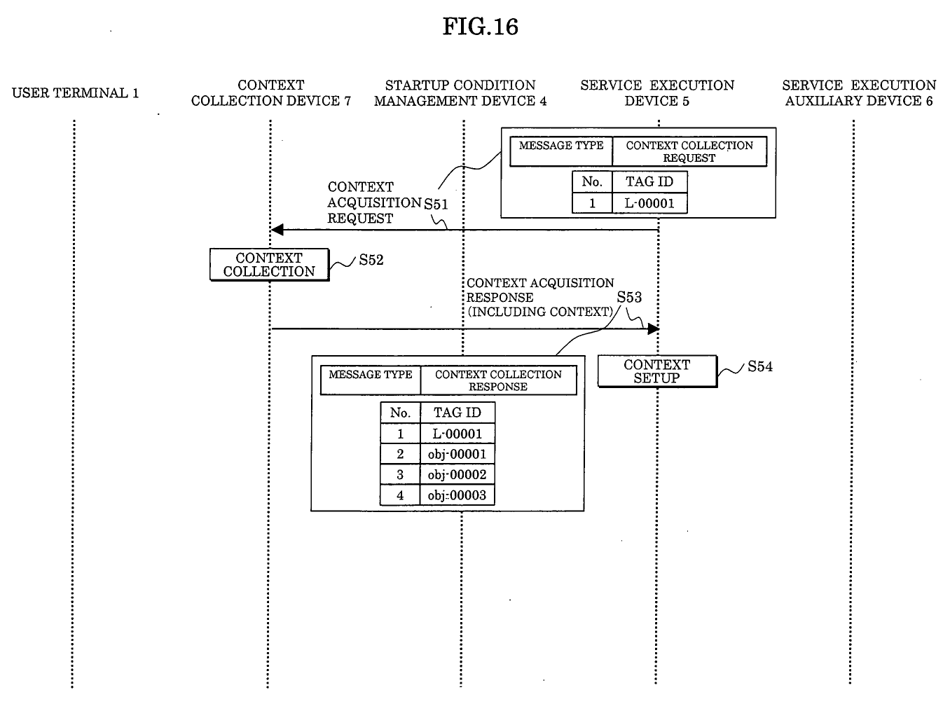

Context Collection/Setup Sequence (SQ11, 12) by Instructions of Service Execution Device 5: FIG. 16

When the service execution device 5 receives the service startup request from the startup condition management device 4, optimum resources within the resources 2 can not be selected only by the context included in the service startup request in some cases. In order to avoid these cases, it is preferable that the service execution device 5 itself independently holds the context. Accordingly, the following sequence is executed.

(1) The service execution device 5 transmits the context collection request to the context collection device 7 (at step S51). The same context collection request as that of the context collection/setup sequence SQ1 by the user's instructions shown in FIG. 11 is performed in this case, as shown in FIG. 16.

(2) The context collection device 7 either collects required context or converts context held into an appropriate form (at step S52).

(3) The context collection device 7 transmits the message including the context as the context collection response to the service execution device 5 (at step S53). Also in this case, as shown in FIG. 16, the same example as the case of the context collection by the user is indicated.

(4) The service execution device 5 sets up the received context as the context of the user (at step S54).

Thus, the service execution device 5 obtains user's context for selecting an output destination device or output information in some cases. Namely, when the service startup is applied from the startup condition management device 4, if the service execution device 5 does not have the context, the context can not be used. Therefore, it is required to perform a context collection before the comparison at the startup condition management device 4 upon performing services by using the context. Thus collected context can be used to determine the distributed contents upon distributing information. Accordingly, it is needless to say that the context collected by the service execution device 5 may be different from the context included in the service startup request.

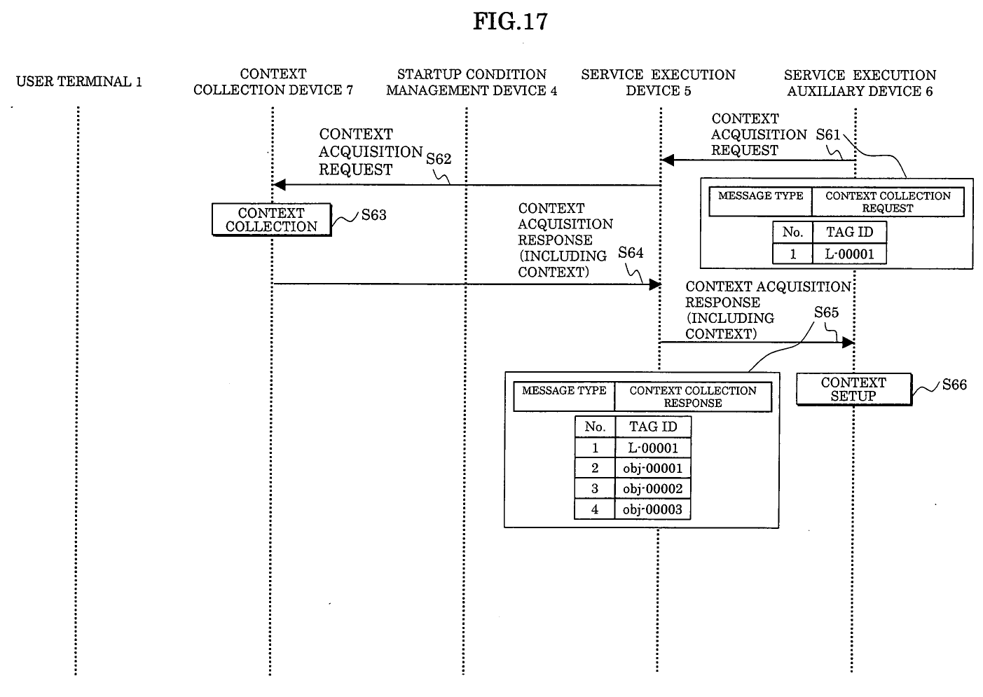

Context Collection/Setup Sequence (SQ11′, SQ12′) by Instructions of Service Execution Auxiliary Device 6: FIG. 17

The service execution auxiliary device 6 collects user's context for selecting the output destination device and the output information in the same way as the above-mentioned service execution device 5 in some cases. Hereinafter, this case will be described.

(1) The service execution auxiliary device 6 transmits the context collection request to the service execution device 5 (at step S61). The example of this context collection request, as shown in FIG. 17, is the same as that of the service execution device of FIG. 16.

(2) The service execution device 5 transmits the context collection request to the context collection device 7 (at step S62).

(3) The context collection device 7 either collects the required context or converts context held into an appropriate form (at step S63).

(4) The context collection device 7 transmits the message including the context as the context collection response to the service execution device 5 (at step S64).

(5) The service execution device 5 transfers the collected context collection response to the service execution auxiliary device 6. The context collection response in this case is also the same as that of the service execution device in FIG. 16.

(6) The service execution auxiliary device 6 sets up the received context as the user's context (at step S66).

It is to be noted that when a service is started up by the instructions of the user or the service execution device in each of the above-mentioned sequences, “unconditional immediate startup” is made a startup condition. In that case, the lifetime=0 sec. is set up as mentioned above.

1. An information distributing system comprising:
a startup condition management device having means which inputs and holds a startup condition per user possessing a user terminal, means which inputs and holds context per user, and means which compares the startup condition with the context for the same user and outputs, when both are coincident with each other, a service startup request including the startup condition and the context; and
a service execution device outputting, when receiving the service startup request, a service execution request corresponding to the user terminal or controllable resources related to the user terminal based on the startup condition and the context included in the service startup request.

2. The information distributing system as claimed in claim 1 wherein the startup condition per user is provided from the user terminal.

3. The information distributing system as claimed in claim 1 wherein the startup condition per user is provided from the service execution device.

4. The information distributing system as claimed in claim 1, further comprising a service execution auxiliary device auxiliarily processing the service execution device, the service execution device obtaining an assistance from the service execution auxiliary device as required to output the service execution request.

5. The information distributing system as claimed in claim 1 wherein the context per user is provided from a user by the user terminal.

6. The information distributing system as claimed in claim 1, further comprising a context collection device, the user terminal transmitting a context collection request to the context collection device, the context collection device transmitting the collected context to the user terminal in response to the request, and then the user terminal providing the context to the startup condition management device.

7. The information distributing system as claimed in claim 1, further comprising a context collection device, the service execution device transmitting a context collection request to the context collection device, the context collection device transmitting the collected context to the service execution device in response to the request, and the service execution device outputting the service execution request based on the received context and the context included in the service startup request.

8. The information distributing system as claimed in claim 4, further comprising a context collection device, the service execution auxiliary device transmitting a context collection request to the context collection device through the service execution device or directly, the context collection device transmitting the collected context to the service execution auxiliary device through the service execution device or directly in response to the request, and the service execution auxiliary device outputting the service execution request based on the received context and the context included in the service startup request.

9. The information distributing system as claimed in claim 1, further comprising a resource management device managing the resources, the resource management device, when receiving a resource retrieval request from the service execution device, responding to the service execution device with corresponding resources, and the service execution device outputting the service execution request for the corresponding resources.

10. The information distributing system as claimed in claim 1 wherein the startup condition includes a lifetime as session information or immediate startup.

11. The information distributing system as claimed in claim 1 wherein the user terminal has an interface for editing or deleting the context held by the startup condition management device.

12. The information distributing system as claimed in claim 1 wherein when a plurality of service execution devices exist, the startup condition includes an identifier of the user terminal at each service execution device and a specific address of the service execution device, and the startup condition management device has a correspondence table of a specific address of each service execution device and an identifier of each user terminal at each service execution device and the startup condition management device.

13. The information distributing system as claimed in claim 5 wherein when a plurality of startup condition management devices exist, the startup condition includes an identifier of the user terminal at each startup condition management device and a specific address of the startup condition management device, and the service execution device has a correspondence table of a specific address of each startup condition management device and an identifier of each user terminal at each startup condition management device and the service execution device.

14. The information distributing system as claimed in claim 2 wherein the startup condition includes a lifetime as session information or immediate startup.

15. The information distributing system as claimed in claim 3 wherein the startup condition includes a lifetime as session information or immediate startup.

16. The information distributing system as claimed in claim 5 wherein the user terminal has an interface for editing or deleting the context held by the startup condition management device.

17. The information distributing system as claimed in claim 6 wherein the user terminal has an interface for editing or deleting the context held by the startup condition management device.

18. The information distributing system as claimed in claim 5 wherein when a plurality of service execution devices exist, the startup condition includes an identifier of the user terminal at each service execution device and a specific address of the service execution device, and the startup condition management device has a correspondence table of a specific address of each service execution device and an identifier of each user terminal at each service execution device and the startup condition management device.

19. The information distributing system as claimed in claim 6 wherein when a plurality of service execution devices exist, the startup condition includes an identifier of the user terminal at each service execution device and a specific address of the service execution device, and the startup condition management device has a correspondence table of a specific address of each service execution device and an identifier of each user terminal at each service execution device and the startup condition management device.

20. The information distributing system as claimed in claim 6 wherein when a plurality of startup condition management devices exist, the startup condition includes an identifier of the user terminal at each startup condition management device and a specific address of the startup condition management device, and the service execution device has a correspondence table of a specific address of each startup condition management device and an identifier of each user terminal at each startup condition management device and the service execution device.
